(19) United States
(12) Patent Application Publication
(10) Pub. No.: US 2003/0190409 A1
(43) Pub. Date: Oct. 9, 2003

(54) Three-dimensional material library and process for producing a three-dimensional material library

(76) Inventors: Stephan Andreas Schunk, Heidelberg (DE); Jens Klein, Heidelberg (DE); Kurt-Erich Finger, Eppelheim (DE)

Correspondence Address: Stephen D Scanlon, Jones Day, North Point, 901 Lakeside Avenue, Cleveland, OH, 44114, US

(21) Appl. No.: 10/362,960

(22) PCT Filed: Aug. 31, 2001
(86) PCT No.: PCT/EP01/10079

(30) Foreign Application Priority Data
Aug. 31, 2000 (DE) 100 42 871.1

(51) Int. Cl. B05D 1/00

(52) U.S. Cl. 427/8

(57) ABSTRACT

The present invention provides a material library which comprises a plurality of different materials in spatial distribution in a three-dimensional substrate, in which the material composition continuously changes along a hypothetical spatial axis of the substrate and in this manner provides a three-dimensional material library. In addition, the present invention provides a process for producing continuous three-dimensional material libraries which comprise a plurality of different materials in a substrate, in which firstly a first substance is applied to a first surface of a substrate, then a second substance is applied to a second surface region of the substrate which is identical or different to the first surface region, in which then the substances are distributed in the interior of the substrate according to a predefined concentration gradient and then react with one another. In addition, the invention provides a process for determining physicochemical properties of constituents in sections of a three-dimensional material library, in which a first parameter is determined simultaneously at at least two sections using a first sensor, the first parameter giving an indication of a first property of the respective constituents and a further parameter being determined simultaneously by a further sensor, in which the further parameter gives an indication of a further property of the respective constituents. In addition the present invention provides a process for the non-destructive in situ determination of constituents in sections of a three-dimensional material library by using three-dimensional interaction of electromagnetic radiation with constituents of sections of a three-dimensional material library, so that the resulting material libraries can be tested in situ in a simple manner.

The present invention relates to a three-dimensional material library according to the preamble of claim 1, a process for producing three-dimensional material libraries according to the preamble of claim 4 and a process for determining performance properties and/or property characteristics of materials in sections of a three-dimensional material library according to the preamble of claim 18.

The present invention is in the field of combinatorial chemistry, in particular in the field of producing and producing and testing material libraries in the search for useful properties of constituents of such material libraries. This technical field is described intensively both in the patent literature and also in scientific publications.

However, to date solely two-dimensional or pseudo three-dimensional material arrays have been used. Those which may be mentioned as representative for the prior art in this field are U.S. Pat. No. 5,985,356 and U.S. Pat. No. 6,004,617, each of which relates to the synthesis and testing of two-dimensional material arrays. By employing sputtering techniques and by using microstructured masks, very large material fields may be generated fully automatically in a very small space. By successive use and, if appropriate, rotation of the masks, different components can be deposited on defined regions. Temperature treatment subsequently to the deposition produces between the approximately 100 nm thick layers a material library having a number of different materials. The extension of this concept to three-dimensional substrates and material libraries is neither mentioned nor obvious in these publications.

In addition, U.S. Pat. No. 6,045,671 discloses further details on the masking technique in the generation of material libraries in two dimensions by sputtering the different materials. The production of three-dimensional arrays is mentioned marginally in this application, the individual building blocks of the material library being situated there in discrete states spatially separated from one another in honeycombs of a substrate having a honeycomb-like structure.

In addition, U.S. Pat. No. 6,063,633 describes a process for testing a multiplicity of materials for their catalytic activity. However, there also, only arrangements are defined in which possible catalytically active components in the form of points or layers are arranged in two-dimensional fields on a support. Likewise, the materials can be disposed on the inner walls of channels, these channels passing through the entire support. No indications are given of preparation techniques for producing such material libraries.

It was therefore the object of the present invention to provide a three-dimensional material library and a process for its production and a process for testing materials of a three-dimensional material library using which it is possible to accelerate or optimize the synthesis and characterization of material libraries in comparison with the abovementioned processes and apparatuses and thus to obtain material libraries which are further improved with respect to the number of different materials per unit of space of the material library, that is to say of the material layers within the material library, i.e. have a higher material density.

These and other objects are achieved by an inventive material library by means of the fact that the material library comprises a plurality of different materials which are arranged spatially distributed in at least one section of a three-dimensional substrate, the material composition or material nature or material composition and material nature changing continuously along at least one freely selectable spatial axis of the substrate.

The three-dimensionality of the inventive material library advantageously exploits all three spatial dimensions, so that it is possible to achieve a material density as high as possible for each spatial unit (section) maximally available for the synthesis and to have a continuous distribution along a spatial axis (axis in space) or a plurality of spatial axes of the substrate. Thus, in particular, the production of what are termed material fields, that is to say the disposition of materials of different composition and/or nature within a substrate is accelerated and optimized. Thus, for example, via continuous three-dimensional gradients, novel materials can be first produced and then tested rapidly and systematically with varying composition and/or nature.

The term “substrate” comprises in principle all three-dimensional devices and bodies having a rigid or semirigid surface which can be either flat or have recesses or bore holes or channels. The substrate must be suitable for receiving the plurality of different materials in at least two different sections. There are no restrictions with respect to the outer shape of the substrate provided that it is a three-dimensional device or a three-dimensional body. Thus the substrate can have the shape of a sphere, ellipsoidal body, a cuboid, a cube, a cylinder, a prism or a tetrahedron.

The substrate on which the materials of the material library are situated comprises a plurality of sections. In this case the term “section” used according to the invention firstly comprises predefined substrate regions which are spatially separated from one another and which are suitable for receiving materials. If the sections are regions of this type, it may be assumed that within the material library the material composition and/or material nature changes discontinuously within the substrate. In the further embodiment of the present invention, in which the material composition and/or material nature changes continuously, the term “section” denotes a possibly infinitesimally small region of the substrate within which according to the invention using a suitable sensor the respective material within the material library is studied. In this case the lower limit of a region of this type depends on the spatial resolution of the measurement method used. Due to the fact that it is required that along at least one spatial axis of the substrate the material composition and/or material nature changes continuously, it is of course also possible that the substrate comprises a combination of predefined substrate regions (e.g. in the x-y-direction) and sections, where the material composition and/or material nature changes continuously (e.g. in the z-direction)

The term “material library” denotes an arrangement comprising at least two, that is a “plurality”, preferably up to 10, further preferably up to 100, in particular up to 1000, and further preferably up to 100 000 substances, or chemical compounds, mixtures of chemical compounds, formulations, which are present on/in a substrate in solid, liquid or gaseous form and are termed hereinafter “materials” for short. This term also comprises “subsubstrates” which are furnished with different materials and, starting from a first or original substrate during the application of the materials to the substrate or before the final determination of the first performance property or property characteristic, are obtained by division, in particular mechanical division.

The term “subsubstrate” used according to the invention, in addition to the definition given in the above section also denotes parts of the substrate of which the latter is composed prior to the production of the three-dimensional material library or prior to the determination of at least one performance property and/or property characteristic of materials. Thus it is also possible firstly to produce one or more three-dimensional material libraries on a subsubstrate of this type independently of one another and then to combine the subsubstrates thus produced to form one substrate using which then in turn the performance properties and/or property characteristics of the materials can be determined.

Preferably, in the context of the present invention, the materials used in the above sense are non-gaseous materials, for example solids, liquids, sols, gels, waxy substances or substance mixtures, dispersions, emulsions, suspensions and solids, particularly preferably solids. In the context of the materials used inventively, these can be molecular and non-molecular chemical compounds or formulations or mixtures, the term “non-molecular” defining materials which can be continuously optimized or changed, in contrast to molecular materials whose structural characteristic can only be changed via a variation of discrete states, that is, for example, variation of a substitution pattern.

The inventively used term “material composition” comprises not only the stoichiometric but also the element composition of the materials to be tested which can be different from material to material. Thus it is possible according to the invention to produce and test material libraries which consist of materials which, although they are identical with respect to their element composition, the stoichiometric composition of the elements making up the material differs between the individual materials; in addition it is possible that the material library is made up of materials each of which is different with respect to its element composition; obviously, it is also possible that the individual materials each differ in stoichiometric and element composition. The term “element” used here refers to elements of the Periodic Table of the Elements.

“Freely selectable spatial axis” is taken to mean hereinafter any hypothetical straight line which can be passed through the substrate in any selectable angle through the geometric centre of the substrate or else through any region of the substrate.

The inventively used term “surface region” denotes the region of the substrate on which the substances constituting the respective material are applied to the substrate; this region, for example in the case of a sphere or an ellipsoidal body, but also with respect to the point of a tetrahedron, can be infinitesimally small, that is to say it is also not excluded according to the invention that the first and/or second substance is in each case applied to the point, for example of a tetrahedron, or to a point of a sphere and is then distributed within the substrate by forces, for example capillary forces.

The term “substance” denotes the chemical components of which the above materials are composed.

The term “performance property” denotes measurable properties of the materials of the material library which can be determined using suitable sensors. Examples of these are mentioned in the further course of the description.

The term “property characteristics” denotes physical, chemical or physicochemical states of the individual materials within the material library; examples which may be mentioned here are oxidation state, crystallinity etc.

“First-order properties” are taken to mean to the greatest extent those property characteristics which are obtained using physical characterization methods, for example X-ray diffraction, LEED structure analysis, EDX, X-ray fluorescence analysis, X-ray photoelectron spectroscopy, auger spectroscopy.

“Second-order properties” is taken to mean those property characteristics which are accessible using physicochemical characterization methods, for example nitrogen adsorption—(surface dimensions, (BET)); TPD—(binding strengths of adsorbates to surfaces or selective chemisorption—size of the surfaces of active centres).

The term “application device”, as used according to the invention means all application devices for chemical substances which are known to those skilled in the art and can be used for producing the materials in question here. The following in particular may be mentioned here: metering devices, for example manual pipettes, semiautomatic pipettes, pipetting robots, spray apparatuses having specific nozzles, coating and sputtering apparatuses.

Preferably, the material composition and/or material nature can be changed continuously along all of the hypothetical spatial axes of the substrate.

Thus, it is particularly advantageously ensured that in a substrate in the entire space available, depending on the gradient along the hypothetical spatial axis of the substrate, as great as possible a number of different materials are available.

Thus it is preferred that the material library is characterized in that the material composition or material nature or material composition and material nature change continuously along two or three orthogonal freely selectable spatial axes of the substrate.

It is preferred that the materials differ in their stoichiometric composition, further preferred that the materials have a different element composition and, in particular, that the materials differ with respect to element composition and their stoichiometric composition.

Thus, in a simple manner, for example the stoichiometry of a material, for example of a solid catalyst, can be varied as desired and subsequently the most suitable stoichiometry for the respective use can be found. It is also possible that via a suitable differing element composition of a multiplicity of catalysts, which although they are substantially similar differ in their elements in at least one element, all the catalyst variants can be tested.

The object underlying the present invention is further achieved by a process for producing a three-dimensional material library, which comprise a plurality of materials which are spatially distributed in sections of a three-dimensional substrate and each have different material composition or material nature or material composition and material nature, wherein the material composition or material nature or material composition and material nature changes continuously along at least one freely selectable spatial axis of the substrate,

in which the process comprises the following steps:

1. applying a first substance to a surface region of the substrate,

2. distributing the first substance in the interior of the substrate.

A further preferred embodiment of the process comprises the further step:

1.1 applying a second substance to a second surface region of the substrate

in which the first and second substance or first and second surface region or first and second substance and first and second surface region are each identical or different from one another, and in which the substances are then distributed in the interior of the substrate according to step 2.

and in a further embodiment if appropriate

3. reacting with one another the first and second substance in the interior of the substrate, in which a plurality of materials are obtained each having a different material composition or material nature or material composition and material nature.

The inventive process thus permits, using the above described steps, at least one substance, preferably two identical substances of different concentration or two substances which are different from one another to mix with respect to their stoichiometric composition in the interior of the substrate along a continuously settable gradient with respect to their concentration, and then to react in a targeted manner with one another, so that in the entire substrate sections of a material library are formed each of different materials. In addition, for example if the first and second substance are identical, the substrate or individual sections of the substrate can be treated in such a manner that within the substrate materials of the same (chemical) composition but different property characteristics, for example degree of oxidation, surface nature, dispersion, are formed and produce a corresponding material library.

The substrate is taken to mean that defined above, the substrate below preferably being made porous, since the distribution of a substance which is preferably applied in liquid phase or in gaseous phase, in the interior of the substrate is thus considerably facilitated.

Preferably, a multiplicity of substances which are identical or different are applied. Depending on the substrate it is thus possible that any complex compounds, for example polymeric oxides or materials bearing faults or doped with individual atoms can be obtained.

This is preferably also achieved by means of the fact that the concentrations of the substances are identical or different.

It is further preferred that the surface regions onto which the substances are applied are identical or different from one another. In the event that the surface regions are identical, a material library can be obtained along a concentration gradient along a three-dimensional region in the interior of the substrate. Subsequently, in a further step, an expanded material library can be obtained in the interior of the substrate along a further region which can be set by a gradient. This procedure can in principle be repeated several times or as often as desired, in each case the composition and/or stoichiometry of the substances within the material library changing.

Furthermore, it is advantageous if the surface regions onto which the substances are applied are always different from one another. This enables the substances to penetrate into the substrate from different sides and only to mix with one another in the interior of the substrate along their previously set concentration gradients and thus be reacted in a specific manner.

It is advantageous if the substances are distributed in the interior of the substrate by the action of a force. This force, in a further preferred embodiment, can be set in a specific manner, so that the concentration gradients of the respective substances in the interior of the substrate can thus be set in a specific manner. The following forces can be used here: centrifugal force, centripetal force, pressure, capillary traction and force of gravity. This force is preferably force of gravity or capillary forces, with the latter being able to be set in a simple manner by a suitable choice of the pore size of the substrate and viscosity moderators, for example temperature and/or chemical additives, for example surfactants, which are known to those skilled in the art. Preferably, the different substances in the interior of the substrate are connected to one another and are then, or between the individual steps, subjected to a post-treatment or to only one post-treatment. Post-treatments which may be mentioned are in particular thermal post-treatments, for example heating and cooling, treatment with reaction gases, pressure treatment (vacuum or superatmospheric pressure), treatment with liquids, electrolysis, oxidation and reduction, in which case partial oxidations and reductions may also be mentioned here, pyrolysis, treatment with light, radioactivity and X-radiation. The substrate can be subjected to such a treatment as a whole or in partial regions (substrates) thereof, which leads to a multiplicity of novel and different materials. In the context of the present invention it is also possible to impinge two substrates identically with substances and then to vary one or more of the post-treatments.

In particular, it is preferred that the substrate is a porous body. Porous bodies of this type can have micropores, mesopores, macropores according to the IUPAC definition or a combination of two or more thereof, in which case the pore distribution can be monomodal, bimodal or multimodal. Preferably, the bodies have a multimodal pore distribution having a high [lacuna], that is to say more than 50% macropores. Porous bodies or materials for such bodies which may be mentioned are: foamed ceramics, metallic foams, metallic or ceramic monoliths, hydrogels, polymer foams, in particular PU foams, composites, sintered glasses or sintered ceramics.

Solid or porous bodies, for example metal bodies, ceramics, glasses, plastics, composites, which can be given a corresponding pore structure by suitable processes, can also be used. Such processes may be: drilling processes, milling processes, erosion processes, etching processes, (laser) lithography processes or screen-printing processes.

In a preferred embodiment, such pore systems are arranged in parallel and orthogonally and interpenetrating. These pore systems which are structured in this way can be used for an analysis of the three-dimensional material libraries within the substrate by probe technologies.

Suitable bodies have a BET surface area of from 1 to 1000, preferably from 2 to 800, and in particular from 10 to 400 m²/g.

It is further preferred that the substrate has a plurality of channels. The channels can be continuous, or else only partially continuous.

The term “channel” describes a connection essentially passing through the substrate between two orifices situated on the body surface which permit, for example, the passage of a fluid through the body. The channel can in this case have any desired geometry, it can have a cross sectional area which is variable over the length of the entire channel or can have preferably a constant channel cross sectional area. The channel cross section can have, for example, an oval, round or polygonal outline with straight or curved connections between the corners of the polygon. Preference is given to a round or simultaneous polygonal cross section. Preferably, all channels in the body have the same geometry (cross section and length) and run substantially parallel to one another. By the use of channels, preferably particularly high concentrations of the respective substances can be introduced into the substrate.

It is further preferred that at least one surface of the substrate is functionalized. Such functionalizations can modify the physicochemical properties of the surface of the substrate. Such properties may be: polarity, acidity, basicity, coating with defined surface species, steric properties, complexing properties, electronic and ionic properties and pore structure. By means of any desired functionalization, for example by applying organic adhesion promoters or compounds which make improved solubility of the applied substances possible, any number of substances differing in their physical properties can be applied, for example hydrophobic and hydrophilic substances or lipophilic and lipophobic substances. Obviously, a plurality of surfaces, or all surfaces of the substrate, can be correspondingly functionalized. For this purpose all processes known to those skilled in the art for functionalizing surfaces are suitable, in which case in particular the wash-coat technique may be mentioned in particular.

It is further preferred that a plurality of subsubstrates are arranged sequentially, in order to obtain a substrate. Particularly large three-dimensional material libraries can be obtained as what are termed three-dimensional material arrays, with each individual substrate being furnished with the same compounds or materials, but it is also possible to combine different substrates with one another, which substrates have substantially different materials, in particular with respect to their element composition. In addition, the substrate can be made up of a plurality of sequentially arranged subsubstrates. Subsubstrates of this type, however, can also be formed by means of the fact that after producing the material and/or during determination of the performance properties and/or property characteristics of the materials, the substrate originally used is divided into a plurality of parts which are then, separately from one another, if appropriate post-treated and/or functionalized and are then separately studied or modified.

Preferably, to apply the individual substances an appropriate application device is used. However, it is also conceivable that substances of this type are applied, for example, only via a pipette, if they are present in the form of liquids, or in the form of an applied powder. It is further preferred that the application device is, for example, a fully automated pipetting robot which applies concentrations and amounts under automatic control.

It is advantageous that the substrate is rotated through an adjustable angle before the application of one or more substances. This has the result that at in each case different positions of the surface different or else identical substances can be applied which can be incorporated into the substrate at different sides along a continuous gradient. Thus, for example, in the event that a substrate is a sphere, a virtually infinite multiplicity of settable angles and thus also substances can be applied. By a suitable shape of the substrate and of the settable angles a particularly large number of different material combinations can be achieved, in this case, particularly advantageously, in a simple manner.

In a further advantageous embodiment, the application device is rotated through an adjustable angle around the substrate before the application of one or more substances. It is thus possible, that instead of rotating the substrate, the application device, provided that it is appropriately conditioned, owing to the easier controllability, for example of an automated application device, a particularly high number of substances are introduced into the substrate.

Preference is given to a three-dimensional material library obtainable by an inventive process, in which case, in a preferred case, the materials can differ in their stoichiometric composition, or in a further advantageous embodiment it is possible that the materials differ in their element composition or are different both stoichiometrically and in their element composition.

The object underlying the present invention is further achieved by a process for determining physicochemical properties of constituents in sections of a three-dimensional material library which comprises the following steps:

(a) determination of at least one performance property and/or property characteristic of at least one material by means of at least one sensor and, if appropriate,

(b) determination of at least one further performance property and/or property characteristic of the at least one material by at least one further sensor.

Preferably, the further parameter is determined only in the materials in the material library in which the measurement of the first parameter has already given an indication of a desired performance property and/or property characteristic.

Preferably, according to the invention materials are produced and if appropriate studied with respect to their performance properties which are potentially suitable as heterogeneous catalysts. Thus these materials are heterogeneous catalysts and/or their precursors, further preferably inorganic heterogeneous catalysts and/or their precursors and in particular solid catalysts or supported catalysts and/or their precursors.

In the context of the present process, the individual materials can be identical or different from one another.

Firstly, if necessary, the constituent can be activated in one section, for example in the case of a catalyst. This can be carried out by thermal treatment under inert gases or reactive gases or other physical and/or chemical treatments. Subsequently, the substrate is brought to a desired reaction temperature and then a fluid starting material which can be a single compound or a mixture of two or more compounds is passed through or along one, a plurality or all of the sections of the substrate.

The fluid starting material, consisting of one or more reactants, is generally liquid, or preferably gaseous. Preferably the testing of, for example oxidation catalysts, is performed by impinging in parallel or sequentially individual, a plurality of or all sections of the material library with a gas mixture of one or more saturated, unsaturated or polyunsaturated organic starting materials. Those which may be mentioned here, for example, are hydrocarbons, alcohols, aldehydes etc., and oxygenated gases, for example air, O₂, N₂O, NO, NO₂, O₃ and/or, for example, hydrogen. In addition, an inert gas, for example nitrogen or a noble gas, may be present. The reactions are generally carried out at temperatures from 20 to 1200° C., preferably at from 50 to 800° C. and in particular at from 80 to 600° C., the separate parallel or sequential removal of the respective streams from the individual, a plurality of, or all, sections being ensured by means of a suitable device.

The present invention thus relates to a process in which, before step (b), a starting material is introduced into at least two sections which are separate from one another in the material library for carrying out a chemical and/or physical reaction in the presence of at least one material of the respective section and after flowing through the section an effluent stream is obtained.

The resulting effluent stream, comprising at least one reaction product, is then collected either from individual or a plurality of sections of the substrate and preferably analysed separately, successively or preferably in parallel, if an analysis of the effluent stream according to the process according to the invention is necessary for the respective section.

A plurality of reactions, each interrupted by a purge step using a purge gas, can also be carried out successively at the same or different temperatures and analysed. Obviously, identical reactions at different temperatures are also possible.

Preferably at the beginning of the process the collected effluent stream of the entire library is analysed in order to establish whether a reaction is taking place at all. In this manner, groups of building blocks can very rapidly be analysed as to whether they have any useful properties, for example catalytic properties. Obviously, after carrying out this coarse screening, again individual groups of building blocks can be analysed together in order in turn to establish which groups of building blocks have catalytic properties, if in the material library a plurality of such groups of building blocks are present.

The present invention permits the automated production and catalytic testing for the purpose of high throughput screening of, for example, heterogeneous catalysts for chemical reactions, in particular for reactions in the gas phase, very particularly for partial oxidations of hydrocarbons in the gas phase by molecular oxygen (gas-phase oxidations).

Reactions or conversions suitable for testing are described in G. Ertl, H. Knötzinger, J. Weitkamp (Editors): “Handbook of Heterogeneous Catalysis”, Wiley VCH, Weinheim, 1997. Examples of suitable reactions are principally listed in this reference in Volumes 4 and 5 under numbers 1, 2, 3 and 4.

Examples of suitable reactions are the decomposition of nitrogen oxides, ammonia synthesis, ammonia oxidation, oxidation of hydrogen sulphide to sulphur, oxidation of sulphur dioxide, direct synthesis of methyl chlorosilanes, oil refining, oxidative coupling of methane, methanol synthesis, hydrogenation of carbon monoxide and carbon dioxide, conversion of methanol into hydrocarbons, catalytic reforming, catalytic cracking and hydrocracking, coal gasification and liquefaction, fuel cells, heterogeneous photocatalysis, synthesis of ethers, in particular MTBE and TAME, isomerizations, alkylations, aromatizations, dehydrogenations, hydrogenations, hydroformylations, selective or partial oxidations, aminations, halogenations, nucleophilic aromatic substitutions, addition reactions and elimination reactions, dimerizations, oligomerizations and metathesis, polymerizations, enantioselective catalysis and biocatalytic reactions and for material testing, and in particular for determining interactions between two or more components at surfaces or substrates, in particular in composite materials.

The take-off lines of effluent streams of the respectively selected sections comprise at least one reaction product and/or the starting material which is preferably obtained separately from the respective sections. This preferably takes place via a device which is connected gas-tightly to the respective sections. Those which may be mentioned in particular are: sample take-off using a suitable flow circuit, for example valve switches and mobile capillary systems (sniffing apparatus). In a particularly preferred embodiment, sniffing apparatuses are used which have a spatially localized heat source, for example a point heat source, or are connected to an apparatus which can generate and/or feed spatially localized heat. This heat source coupled to the sniffing apparatus permits the region under test of the material library to be heated selectively and a reaction to be initiated only in this region. The individual effluent streams of the individual sections, a plurality of sections or all sections can be removed separately and then analysed separately via a valve switch.

The, for example, computer-controlled, mechanically movable sniffing apparatus comprises a sniffing line or sniffing capillary for the effluent stream to be taken off, which is essentially automatically positioned on, in and/or above the outlet of the respective section and then takes off the effluent stream. Details with respect to the arrangement of such an apparatus may be taken from WO 99/41005.

In principle there is freedom in the choice of the measurement method, but it should in this case be a comparatively rapid and simple measurement technique, since a great number of sections are to be analysed. The purpose of this first measurement is preferably a preselection of those sections which are to be analysed further.

In particular, sensors which may be mentioned are: infrared thermography, infrared thermography in combination with mass spectroscopy, mass spectroscopy, GC, LC, HPLC, micro GC, dispersive FT-IR spectroscopy, Raman spectroscopy, NIR, UV, UV-VIS, NMR, GC-MS, infrared thermography/Raman spectroscopy, infrared thermography/dispersive FT-IR spectroscopy, colour detection with chemical indicator/MS, colour detection with chemical indicator/GC-MS, colour detection with chemical indicator/dispersive FT-IR spectroscopy, photoacoustic analysis, and tomographic NMR methods.

Particular preference is given to mass spectrometry and measurement methods coupled thereto, and to tomographic NMR methods, optionally using specific probe molecules.

Furthermore, infrared thermography is preferably used, which can be implemented simply using an infrared camera. In this case the temperature development of the individual sections may be taken from the infrared image recorded, preferably using digital image processing. For a small number of sections, if appropriate a temperature sensor can be assigned to each individual section, for example a pyrometric element or a thermocouple. The results of the temperature measurement for the respective sections can all be supplied to a data processing system which preferably controls the inventive process. Further details on this method can be taken from WO 99/34206 and DE-A 100 12 847.5, the contents of which in this respect are completely incorporated into the context of the present application.

In order to eliminate substantially interfering effects, the substrate together with the sections to be studied should preferably be situated in a thermally insulated housing having a controlled atmosphere. If an infrared camera is used, this should preferably be situated outside the housing, observation of the substrate being made possible via infrared-transparent windows, for example made of sapphire, zinc sulphide, barium difluoride, sodium chloride etc. On the basis of the results of measurement of the first parameter, the sections for which at least one further performance property can be measured, are selected using a data processing system or a computer. In this case, different selection criteria are also conceivable. Firstly, those sections can be selected for which the first parameter is “better” than a predefined limit value, secondly, a predefined percentage of all sections or materials on a substrate for measuring the second parameter can also be selected. The said minimum requirements or the number of sections to be selected depends firstly on the respective quality requirements of the materials to be studied and secondly on the time which is available to study a substrate.

If a limit value can be preset with respect to the minimum requirement of the first measured value, this need not be constant for all sections of a substrate, but it can, for example, be preset as a function of other properties of the respective construction elements of the individual sections.

Measurement of the at least one further parameter (performance properties and/or property characteristic) is preferably carried out on the effluent stream of the selected sections. In principle the further sensor is not subject to any restrictions provided that it is suitable for measuring a further parameter which gives indications of a further property of the building block under study.

Preferably, this further sensor is based on a spectroscopic method which is selected from the group comprising mass spectrometry, gas chromatography, GC/MS spectroscopy, Raman spectroscopy, infrared spectroscopy, UV/VIS spectroscopy, NMR spectroscopy, fluorescence spectroscopy, ESR spectroscopy and Mössbauer spectroscopy. On the basis of these preferred techniques, more precise information may be obtained regarding the effluent stream of the respective sections or building blocks. By means of these spectroscopic methods, the concentration of a sought-after product, or the concentration of parallel products and the residual concentration of the starting materials can be determined, from which, for example, information on the selectivity may be derived for catalytic building blocks.

For mass spectrometry, preferably a quadrupol mass spectrometer is used, although TOF mass spectrometers (real-time mass spectrometers) or sector field mass spectrometry can also be used. The effluent stream of the sections under test is fed to the mass spectrometer or other sensors preferably via a line system, with this in particular being a sniffing capillary, which is positioned in the effluent stream of the respective sections using a robotic system which can be shifted in x, y and z directions.

For optical systems such as Raman spectrometers and FTIR spectrometers, it is conceivable that light can be directed using sampling mirrors onto respective sections under test, or can be decoupled from each of the sections under test.

The process of the invention can be carried out either on the substrate, as obtained after the production, but also, more preferably, after dividing the substrate into previously defined individual three-dimensional bodies. The prior division into smaller bodies, which is achieved, for example, by sawing a substrate, enables a further particularly targeted selection of the individual constituents in the sections of material libraries in three dimensions.

Preferably, the process is carried out non-destructively, the substrate being permeated by a three-dimensional network of channels intercepting each other essentially orthogonally. Thus, preferably, relatively large units and sections of the material library are already preset by the channel geometry, so that the sections are situated precisely between the channels, but on the other hand it is preferably possible to introduce directly into the channels a sensor for determining a physicochemical parameter of a constituent of a section of the three-dimensional material library, so that specifically using such microsensors, properties of previously selected sections of the three-dimensional material library can be measured.

It is preferred here that this sensor can be moved in the x, y and z direction, so that it can be moved within the entire channel network in the substrate and can be directed to each individual section of the three-dimensional material library.

Analytical methods which are suitable for a sensor which is connected, for example, to a measurement system by means of fibre-optic methods, are the abovementioned methods.

Advantageously, the channel network is introduced into the substrate before producing the material library. However, it is particularly preferred that the channel network is not introduced into the substrate until after producing the material library, since not introducing the channels until subsequently avoids possible interruption in the concentration gradients or property gradients of the developing materials during the production of the three-dimensional material library.

Preferably, the inventive process for determining physicochemical properties of constituents in sections of a three-dimensional material library is carried out non-destructively, in such a manner that electromagnetic radiation of a defined wavelength is allowed to act on the substrate and, using an analytical apparatus, a three-dimensional reproduction of the interaction of the constituents of the three-dimensional material library with the electromagnetic radiation is prepared. Suitable processes for carrying out such determinations are, for example, NMR tomography or ESR tomography.

It is also possible to impinge the three-dimensional material library with what is termed a “probe fluid”. A part of the fluid, for example an inert or reactive gas, or a corresponding liquid, experiences in or on the constituent(s) of a selected section a change of at least one of its characterizing physicochemical parameters, for example via a chemical reaction/conversion with the respective constituent of the section or via chemisorption and/or physisorption. Subsequently, the “probe fluid” which is changed in this manner in its physicochemical properties can be analysed by suitable methods which are known to those skilled in the art and are also described above, in which case property characteristics, for example of the surface nature or adsorptivity, of the constituent of a section or of an entire section or of a plurality of sections can be determined from the analytical results.

Thus, in a simple manner, without, for example, the substrate being divided in advance into individual further bodies, a three-dimensional picture of the resulting building blocks of the three-dimensional material library can be obtained.

Preferably, this non-destructive analysis is carried out after a starting material flows through the substrate or while it flows through and subsequently after a starting material flows through, so that thus in a simple manner information can be obtained of the state of a possible catalyst system before, during and after a catalytic reaction.

The starting material gas can be passed integrally over the entire substrate or large regions of the substrate, but can also be fed selectively via special capillary apparatuses as mixtures or individual components into any small areas, for example an individual channel, of the substrate from any spatial directions of the substrate.

Preferably, the analysis is controlled by a data processing system, so that suitable sections and constituents in such sections of the three-dimensional material library can be determined particularly rapidly and simply.

It is thus advantageously possible to analyse specifically a constituent of a single section, since in the case of the measurement methods mentioned above of this type a specific selection of a small area of a larger region is also possible.

Further advantages and developments of the invention result from the description, the example and the accompanying drawings.

It is understood that the abovementioned features and the features still to be described hereinafter are useable not only in the respective described combination, but also in other combinations or alone, without departing from the context of the present invention.

The invention is illustrated diagrammatically in the drawings on the basis of examples and is described in detail below with reference to the drawings.

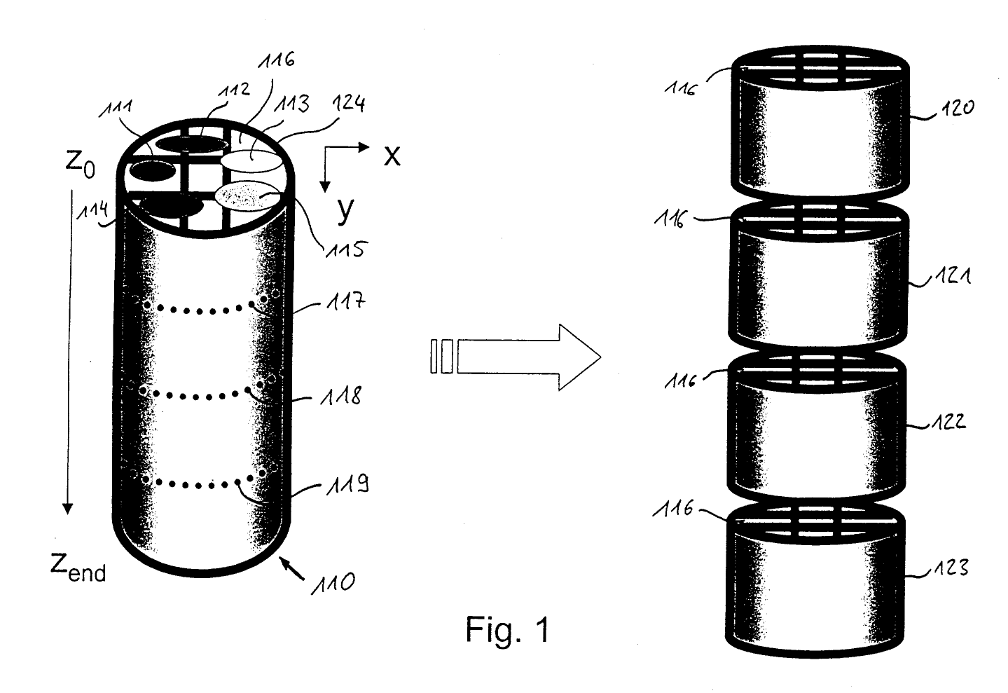

FIG. 1 shows diagrammatically the inventive process for producing a three-dimensional material library.

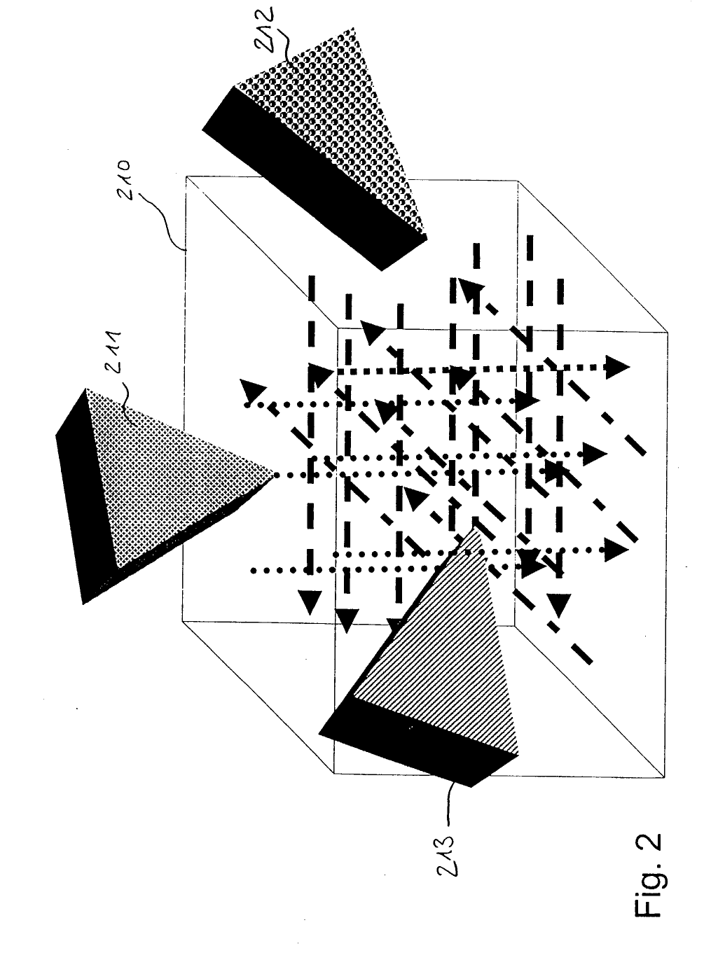

FIG. 2 shows the diagrammatic representation of an inventive three-dimensional material library.

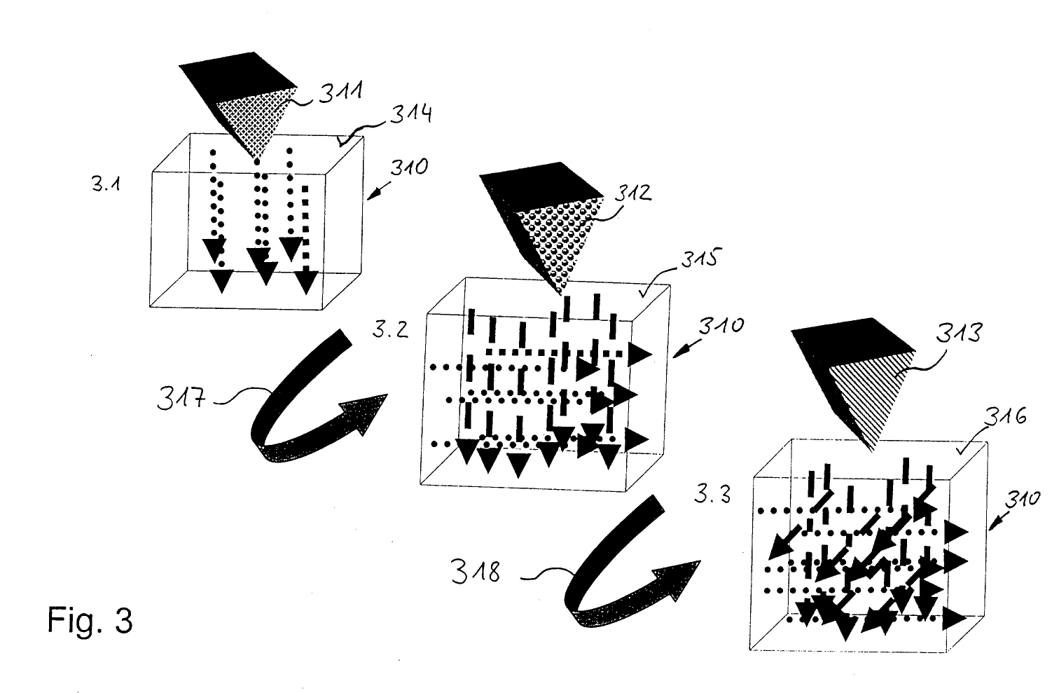

FIG. 3 shows a further embodiment of the inventive process for producing a material library.

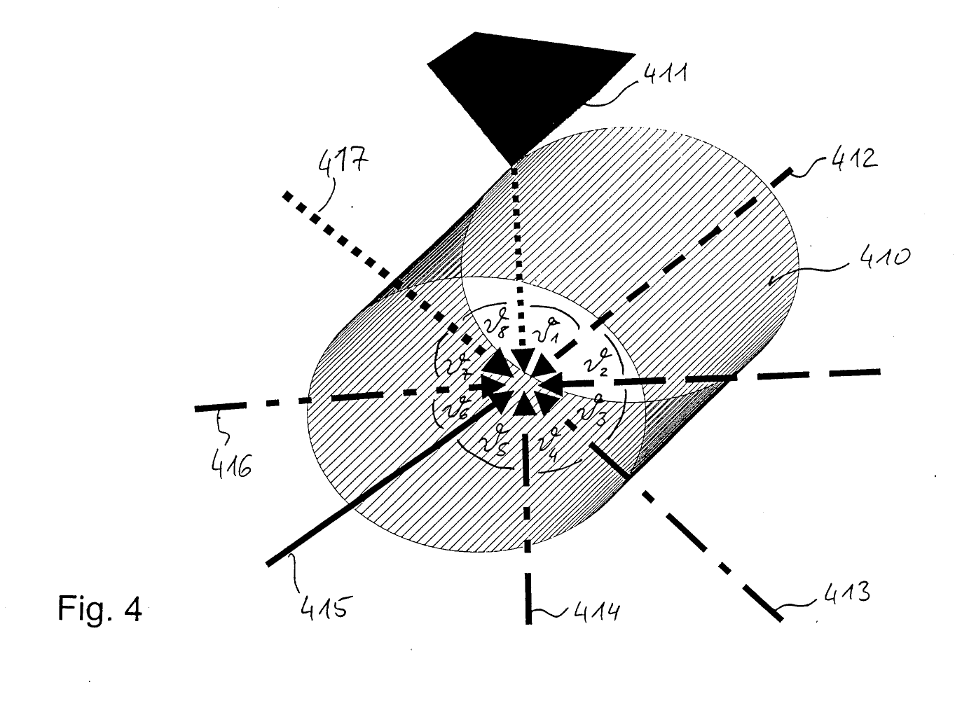

FIG. 4 shows a further embodiment of a three-dimensional material library.

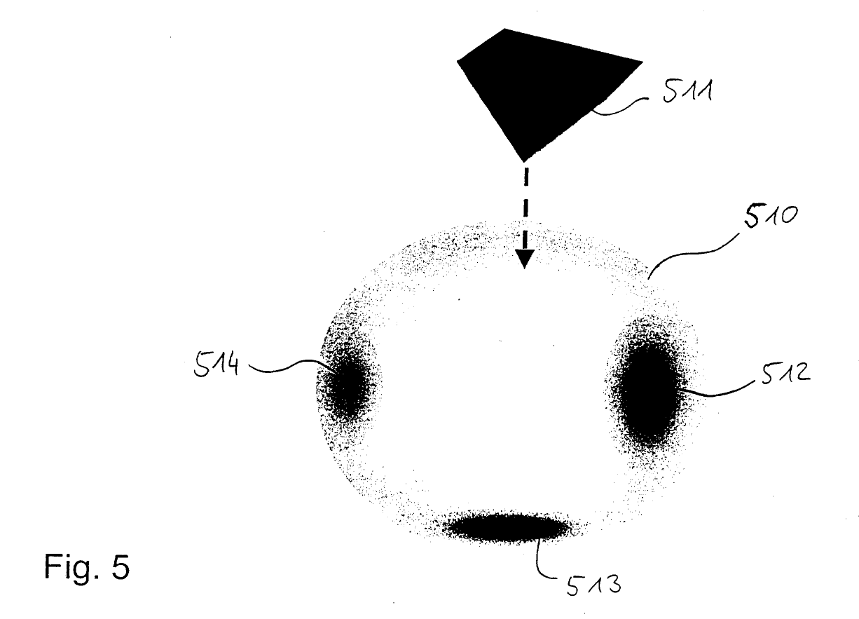

FIG. 5 shows a further embodiment of a three-dimensional material library.

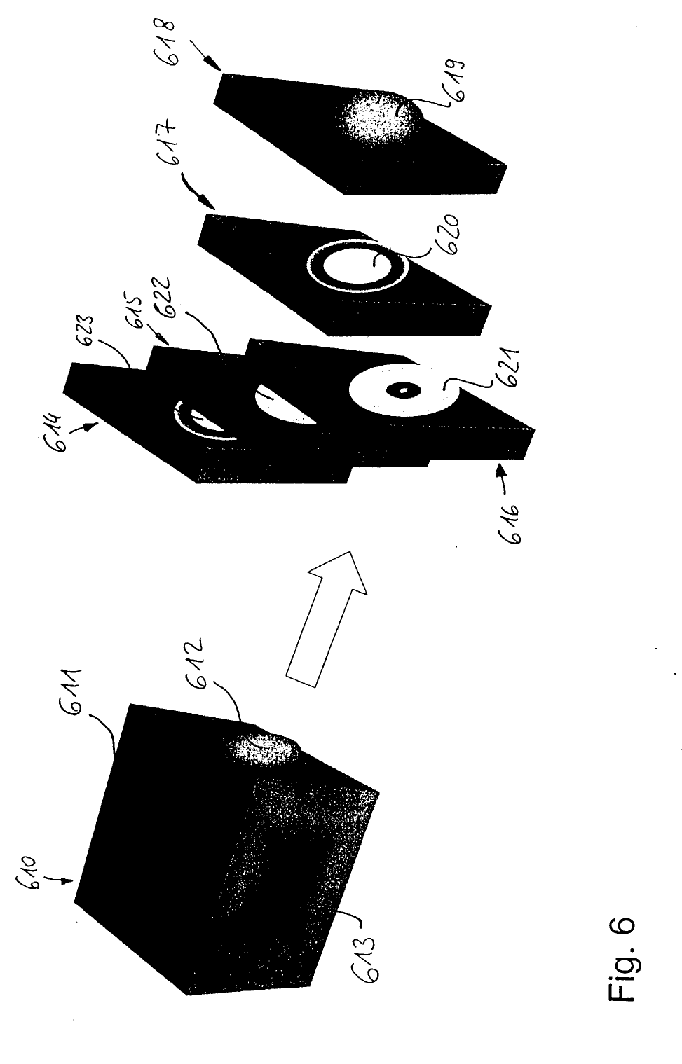

FIG. 6 illustrates diagrammatically the process for testing for physicochemical properties of a three-dimensional material library.

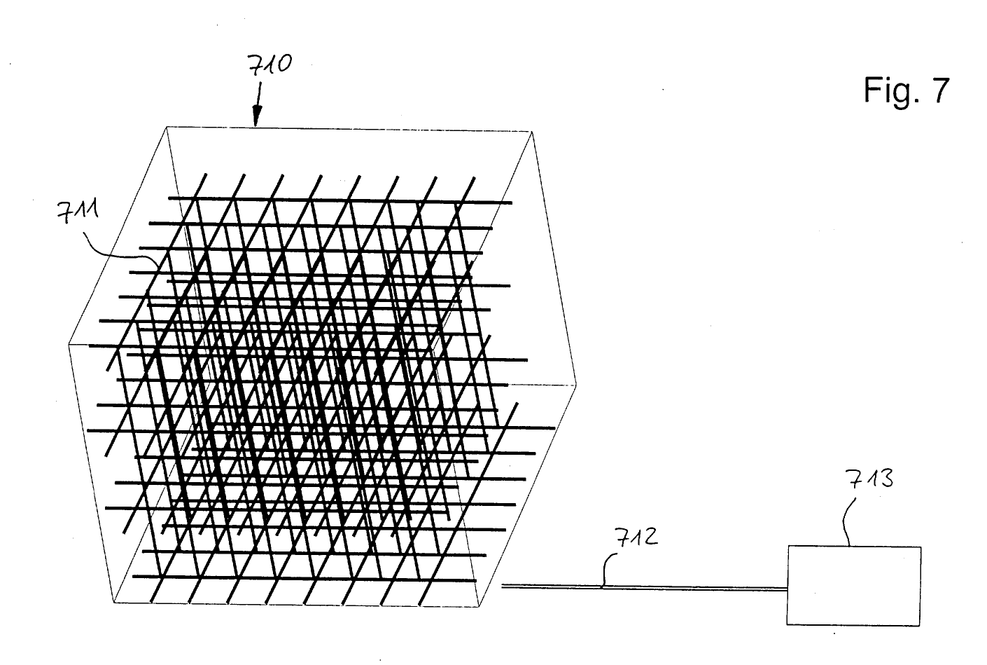

FIG. 7 shows a further embodiment of an inventive three-dimensional material library.

FIG. 1 shows as an example in diagrammatic representation the production of an inventive three-dimensional material library with subsequent first analytical step. A ceramic, porous cylindrical body 110 which has channels is furnished with different volumes of substances 111, 112, 113, 114 and 115 at various points of its surface 124 by means of a pipetting robot which is not shown. As result of forces of gravity and capillary forces in the porous ceramic body, the solutions, depending on the volume applied, run into the total volume of the substrate 110. The substrate in the present example is made of aluminium dioxide, but any porous substrate can be used, for example all ceramics or ceramic materials, foamed glasses, correspondingly porous plastic bodies produced by extrusion or coextrusion processes and the like. The material selection is left in this case to those skilled in the art who can use for this purpose materials known per se.

After the precursor solutions have been run in, the substrate 110 was dried for about 4 hours at 80° C. and then calcined for 3 hours at 500° C.

In the present case, the following solutions were applied:

| | | | | |
|---|---|---|---|---|
| Substance 112 | Bi(NO₃)₃ | 0.25 | M | 50 □1 |
| Substance 113 | (NH₄)₂Cr₂O₇ | 0.715 | M | 150 □1 |
| Substance 114 | (NH₄)₃WO₃ | 0.5 | M | 200 □1 |
| Substance 111 | Co(NO₃)₃ | 4 | M | 20 □1 |
| Substance 115 | V₂(C₂H₄O₄)₅ | 0.45 | M | 80 □1 |

The substrate in the present case had a diameter of 10 mm and a length of 50 mm.

Sample preparation for detection and validation of the three-dimensional material synthesis according to one of the inventive abovedescribed processes is carried out next. The arrow symbolizes that the substrate 110 is equidistantly divided by three hypothetical cuts 117, 118, 119 into four further smaller bodies 120, 121, 122 and 123, each of which again represents a material library within the meaning of the present invention. The division can be performed in this case by suitable measures known per se to those skilled in the art, for example laser cutting or else sawing. Preferably, the substrate 110 is equidistantly divided by cutting into same size pieces. However, other cuts in a further embodiment are also possible. A division of this type can also be performed as early as between the individual steps of introducing the substances into the substrate, in which case subsubstrates are formed which can then be further processed independently of one another within the context of the present invention. These subsubstrates can then be subjected separately to a treatment and/or determination of a performance property. Subsubstrates of this type can be recombined by any combination to form a single substrate and then subjected to a joint treatment and/or determination of a performance property. These measures further decisively increase the possible diversity of the materials or material libraries to be prepared or studied within the context of the present invention.

In the z direction of the substrate 110, depending on solution volume applied and size of the area of application, concentration gradients of the metal salt solutions have formed. By means of capillary forces, the solutions of the substances 111, 112, 113, 114 and 115 also distribute themselves in the horizontal x y plane of the substrate 110.

After cutting the substrate 110 into the smaller bodies 120, 121, 122, 123, which also have pores 116, the smaller bodies are mentioned by means of micro x-ray fluorescence mapping. The exposed surface of the ceramic slice of each body is scanned with a focused x-ray beam. A spectrum is recorded for each measuring point. By this means the concentration distributions of the corresponding metal salt solutions or compounds obtained by reactions of the individual substances can be reflected by proportional colour intensities. On each cut surface of the individual bodies 120, 121, 122 and 123, different gradients and concentrations of the resulting compounds are visible.

These gradients can be controlled firstly by the volume of the substances applied, and also by the size of the surface area onto which the substances are applied, and secondly by applying external forces, for example carrier gases or reactive gases and the like.

FIG. 2 shows diagrammatically a three-dimensional material library in a cuboidal substrate 210. In this case three different substances 211, 212 and 213 have been applied in each case to different surfaces of the substrate and have distributed themselves in the substrate along the directions symbolized by arrows. The course of the concentration gradient of substance 211 is represented by dotted arrows, that of substance 212 by dashed dark arrows and that of substance 213 by dashed light arrows. As can be seen in FIG. 2, the respective substances 211, 212, 213 interpenetrate along their concentration gradients in the interior of the substrate 210 and thus form constituents of sections of a three-dimensional material library at their overlap surfaces.

FIG. 3 shows diagrammatically a process for producing a three-dimensional material library, for example for a cuboidal substrate 310 similar to FIG. 2. On a first surface 314 of the substrate 310 a substance 311 is applied on a defined substrate 310 surface region which is not shown in the drawing. This substance is distributed either by capillary forces or forces of gravity or by applying an exactly defined gas pressure in the substrate 310, represented by the dotted arrows in FIG. 3.1.

The substrate is then rotated by 90° by means of suitable means which are not shown in the drawing, which rotation is indicated by the first arrow 317. In FIG. 3.2, a further substance 312 is applied to the substrate 310 on a second surface 315 which is different from the first surface 314, which substance distributes itself in the substrate 310 in a similar manner to FIG. 3.1 along a concentration gradient which is shown by dotted arrows. At the end of the distribution the substrate is again rotated by 90° using means not themselves shown, which is indicated by the arrow 318. In FIG. 3.3 a third substance 313 is applied to a third surface 316 of the substrate 310 which is different from surfaces 314 and 315, which substance also distributes itself in the interior of the substrate 310 as described above. Thus three different substances 311, 312, 313 have been applied in all three three-dimensional directions x, y and z direction of the substrate. These substances distribute themselves along precisely defined and adjustable concentration gradients in the interior of the substrate and thus form a three-dimensional material library.

FIG. 4 shows a further diagrammatic representation of an inventive material library. FIG. 4 shows a cylindrical substrate 410. The substrate can in this case also again consist of ceramic or another material described under FIG. 1.

A first substance 411 is applied to the curved surface of the cylindrical substrate 410 and distributes itself in the interior of the substrate along a first dotted line according to a concentration gradient. After the distribution of the substance 411 in the interior of the substrate 410 the substrate 410 is rotated by a predefined angle θ1 and a further substance 401 can be applied in a similar manner to 411.

In FIG. 4, further angles of rotation, θ2 to θ8, are shown, so that further substances 413, 414, 415, 416 and 417 can be applied to the substrate. Naturally it is also possible to use fewer angles of rotation Ox and thus also to introduce fewer different substances. However, it is also possible to use more than the eight angles shown by way of example and thus also to produce highly complex molecules and compounds.

FIG. 5 shows as an example a further embodiment of a three-dimensional material library. In FIG. 5 a spherical substrate 510 is used which is made of a material as described above. A sphere offers a particularly high freedom of angles θx, by which the substrate can be rotated after application of a substance 511. FIG. 5 shows how a substance 511 is applied to the substrate 510. Further substances 512, 513 and 514 have already penetrated into the substrate 510 and already form predefined concentration gradients in the interior of the substrate 510. According to the desired end product, thus substance 511 can also be introduced in accordance with a predefined concentration gradient, and thus, for example, quaternary systems can be produced in a particularly simple manner.

Owing to the particularly high freedom of possible angles, a spherical substrate according to FIG. 5 also enables the production of polymeric systems.

FIG. 6 shows as an example the production of smaller bodies from an inventive three-dimensional material library. In this case the substrate 610, which has been charged, for example, with three different substances 611, 612 and 613, is divided after the inventive post-treatment into disk-shaped bodies 614, 615, 616, 617 and 618. The division is performed by a measure known per se to those skilled in the art, for example laser cutting or other suitable measures. Obviously, the bodies 614 to 618 can again be divided into further smaller units. On the bodies 614 to 618, owing to the concentration gradients in the interior of the original substrate 610, different material systems 623, 622, 621, 620 and 619 have formed. These can then be analysed using methods which are known per se and are described above and can then be validated.

FIG. 7 shows as an example a substrate 710 which is permeated by a network of interpenetrating channels 711. This network 711 can be introduced into the substrate either before or after the production of an inventive three-dimensional material library. After production of a three-dimensional inventive material library, a probe 712, which can be moved in x, y and z direction, can be introduced into the network 711. By this means precisely defined individual sections of the three-dimensional material library can be approached specifically and tested with respect to their suitability for potential useful properties. The probe 712 is connected, for example, via fibre optic cables to an analytical instrument 713. However, other connections are also conceivable. The analytical instrument analyses the data received by the probe 712, for example, in the case of a chemical reaction, in which a starting material is introduced into the network 711 and which reacts in the presence of a constituent of a section of the inventive three-dimensional material library. The analytical methods in particular described above are used here.

1. Material library comprising a plurality of different materials which are arranged spatially distributed in at least one section of a three-dimensional substrate, characterized in that the material composition or material nature or material composition and material nature changes continuously along at least one freely selectable spatial axis of the substrate.

2. Material library according to claim 1, characterized in that the material composition or material nature or material composition and material nature change continuously along two or three orthogonal freely selectable spatial axes of the substrate.

3. Material library according to claim 1 or 2, characterized in that the individual materials each differ in their stoichiometric composition or element composition or stoichiometric composition and element composition.

4. Process for producing a three-dimensional material library, which comprise a plurality of materials which are spatially distributed in sections of a three-dimensional substrate and each have different material composition or material nature or material composition and material nature, wherein the material composition or material nature or material composition and material nature changes continuously along at least one freely selectable spatial axis of the substrate,
in which the process comprises the following steps:
1. applying a first substance to a surface region of the substrate,
2. distributing the first substance in the interior of the substrate.

5. Process according to, claim 4, characterized in that it comprises the following further step 1.1 after step 1:
1.1 applying a second substance to a second surface region of the substrate
in which the first and second substance or first and second surface region or first and second substance and first and second surface region are each identical or different from one another, and in which at least one of the substances is then distributed in the interior of the substrate according to step 2.

6. Process according to claim 5, characterized in that it comprises the following further step 3.:
3. reacting with one another the first and second substance in the interior of the substrate, in which a plurality of materials are obtained each having a different material composition or material nature or material composition and material nature.

7. Process according to one of claims 4 to 6, characterized in that the steps 1 and 2, or 1 and 1.1, or 1 and 1.1. and 2, or 1 to 3 are repeated a plurality of times.

8. Process according to one of claims 4 to 7, characterized in that the at least one substance is distributed in the substrate by the action of a force.

9. Process according to claim 8, characterized in that the substances come into contact with one another during the distribution.

10. Process or material library according to one of the preceding claims, characterized in that the substrate is made up of a plurality of subsubstrates which are arranged sequentially.

11. Process or material library according to one of the preceding claims, characterized in that the substrate is a porous body.

12. Process or material library according to one of the preceding claims, characterized in that the substrate has a plurality of channels.

13. Process or material library according to one of the preceding claims, characterized in that at least one section of the substrate is functionalized.

14. Process according to any one of claims 4 to 13, characterized in that the substrate or at least one subsubstrate or individual sections of the substrate or of the at least one subsubstrate are subjected to a post-treatment between or after steps 1. to 3., as defined in claims 4 to 7.

15. Process according to one of claims 4 to 14, characterized in that to apply the substances an application device is used.

16. Process according to claim 15, characterized in that the application device is rotated through an adjustable angle after the application of the first substance and/or in that the substrate is rotated through a defined freely selectable angle after the application of the first substance.

17. Three-dimensional material library obtainable by a process according to one of claims 4 to 16.

18. Process for determining at least one performance property and/or property characteristic of materials in sections of a three-dimensional material library according to one of claims 1 to 3 and 17 which comprises the following step:
(a) determination of at least one performance property and/or property characteristic of at least one material by means of at least one sensor.

19. Process according to claim 18 which additionally comprises the following step (b):
(b) determination of at least one further performance property and/or property characteristic of the at least one material by at least one further sensor.

20. Process according to claim 18 or 19, characterized in that the substrate is divided into a plurality of subsubstrates before determination of the performance property and/or property characteristic.

21. Process according to one of claims 18 to 20, characterized in that the further performance property and/or property characteristic is determined only for a selected group of materials.

22. Process according to claim 21, characterized in that the selection of the materials for the further measurement for determination of the further performance property and/or property characteristic depends on the result of the determination of the first performance property and/or property characteristic.

23. Process according to one of claims 18 to 22, characterized in that the materials for the further measurement are selected automatically by a data processing system.

24. Process according to one of claims 18 to 23, characterized in that, before step (b), at least one starting material is introduced into at least two sections which are separate from one another in the material library for carrying out a chemical and/or physical reaction in the presence of at least one material of the respective section and after flowing through the section an effluent stream is obtained.

25. Process according to one of claims 18 to 24, characterized in that the sensor is based on a determination method which is selected from the group consisting of:
infrared thermography, infrared thermography in combination with mass spectroscopy, mass spectroscopy, GC, LC, HPLC, micro-GC, dispersive FT-IR spectroscopy, Raman spectroscopy, NIR, UV, UV-VIS, NMR, GC-MS, infrared thermography/Raman spectroscopy, infrared thermography/dispersive FT-IR spectroscopy, colour detection by chemical indicator/MS, colour detection by chemical indicator/GC-MS, colour detection by chemical indicator/dispersive FT-IR spectroscopy, photoacoustic analysis and tomographic NMR methods.

26. Process according to one of claims 18 to 24, characterized in that the substrate is permeated by a three-dimensional network of channels interpenetrating one another essentially orthogonally.

27. Process according to claim 26, characterized in that the three-dimensional network is introduced into the substrate before or after producing the material library.

28. Process according to one of claims 26 or 27, characterized in that at least one sensor is introduced into the three-dimensional network for determination of the performance property and/or property characteristic of at least one material of a section of the three-dimensional material library.

29. Process according to claim 28, characterized in that the sensor can be moved in the x, y and z direction.

30. Process according to one of claims 18 to 29, characterized in that the substrate is brought into contact with electromagnetic radiation of a defined wavelength and, using an analytical apparatus, a three-dimensional reproduction of the interaction of the materials of the three-dimensional material library with the electromagnetic radiation is prepared.

31. Process according to one of claims 18 to 30, characterized in that, during and/or after the contacting of the substrate with electromagnetic radiation, at least one starting material for carrying out a chemical and/or physical reaction in the presence of at least one material is introduced into at least one section of the three-dimensional material library and then an effluent stream is obtained.

32. Computer program having program code means for carrying out the process according to one of claims 4 to 16 and 18 to 31.

33. Data carrier with computer program according to claim 33.
